(19) United States
(12) Patent Application Publication
(10) Pub. No.: US 2012/0082874 A1
(43) Pub. Date: Apr. 5, 2012

(54) On Demand Power Device

(76) Inventors: Douglas K. Hungerford, Apopka, FL (US); Robert Andrew McNeill, Chuluota, FL (US); Bruce Chesson, Orlando, FL (US)

(21) Appl. No.: 12/898,503

(22) Filed: Oct. 5, 2010

(51) Int. Cl. H01M 10/44

(52) U.S. Cl. 429/52; 429/110

(57) ABSTRACT

An on demand power device which allows users to selectively choose the desired voltage/current/power and/or amp-hour (A/H) capacity output from among a range of output available within the power device. This device relates to batteries used as long-term stand-by or back-up power sources such as for emergency use with a motor vehicle, during camping, vehicle starting/towing, and for power consumer electronics such as mobile phones or a global positioning systems. This device also relates to batteries for usages on water, underwater, on land, under land, in the air or in space which require power at discrete intervals.

### FIELD OF THE INVENTION

The instant invention presents an On Demand Power Device which relates to batteries used as long-term stand-by or back-up power sources such as for emergency use with a motor vehicle, during camping, vehicle starting/towing, and for power consumer electronics such as mobile phones or a global positioning systems. Further, the present invention relates to batteries for usages on water, underwater, on land, under land, in the air or in space which require power at discrete intervals. In addition to the back-up, intermittent and/or emergency use, the instant invention presents an On Demand Power Device which further allows users to selectively choose the desired voltage/current/power and/or amp-hour (A/H) capacity output from the power source from among a range of output available within the power device.

### BACKGROUND OF THE INVENTION

A variety of devices suited to provide power in situations where a stand-by, emergency, or long-life battery is most appropriate.

Extended shelf life or emergency batteries are well known such as U.S. Pat. No. 5,340,662.

For example U.S. Pat. No. 3,666,961 provides an electrical power supply wherein each reserve battery is activated only after the preceding battery has substantially spent its useful life. Another device which provides a plurality of batteries for use as needed include U.S. Pat. No. 3,767,933.

Further switching circuits for managing multiple batteries are well known such as U.S. Pat. No. 5,764,032, U.S. Pat. No. 6,144,189, U.S. Pat. No. 6,957,048, and U.S. Pat. No. 7,009,363.

Batteries having packaging tabs for providing robust power attachment locations are also well known such as U.S. Pat. No. 6,045,946.

Battery housings and/or enclosures for multiple cells are also well know such as U.S. Pat. No. 4,123,598 and U.S. Pat. No. 4,515,872.

What is needed is a stand-by, emergency, or long-life power source or device such as a battery wherein users can selectively choose the desired power output from the power source from among a range of output power available within the power device/source and wherein the selected cell or group of cells can be easily manually activated. Further, the power source/device should be able to provide a range of useful power by means of the power device including a range of battery types and voltages.

### SUMMARY AND OBJECTS OF THE INVENTION

The object of the present invention is to provide an on-demand power device to produce a selected power output once a chemical reaction has been initiated in the selected/activated battery cells. The amount of power generated can be determined by how many battery cells within the power device are activated. The present invention further presents an on demand power device which can include a single cell or a range of battery cell types and voltages. Further the instant invention presents an on demand power device wherein cells within the device may be partitioned to provide users an independent selection of various cell output options by selecting outputs from the partition sections of the cell.

Overall, the present invention allow users to selectively choose the desired power output from the power device/source from among a range of output power available within the power device.

The present invention presents an on demand power device utilizing at least one replaceable battery cell wherein the cell(s) employ a chemical reaction to produce the required power and the cell(s) are inactive until activated. Once the chemical reaction has been initiated, the power device produces power and continues to do so until the chemical reaction ends. The amount of power generated can be determined by how many cells within the power device are activated. A variety of release mechanisms, such as multiple pull tabs, punctures, and/or twist can be utilized to activate the reaction for each cell or cell bank. In this manner the power device can be utilized multiple times with smaller currents for each use or all at one time to provide a large current on a single use. This type of power production also allows the power device to have an optimum shelf life with very little or no loss of potential energy and provides an excellent means of generating power for emergency situations. The power device shall be of varying shapes that allow for easy and/or inconspicuous storage locations inside of vehicles. The power connection can be a typical power port socket and plug assembly found in conventional vehicles. The benefit to this arrangement is that the unit may be plugged in to another device as well as having devices plugged in to it either together or separately.

When emergency situations occur it is imperative that power be available when it is required. Emergencies can vary from automotive breakdowns, power outages from storms, boating emergencies and too many other situations to describe. Conventional battery operated equipment including automobiles, radios, cell phones, flash lights and etc require power. These devices typically utilize conventional rechargeable power such as lead acid, alkaline and lithium batteries that self discharge with time and require regular and frequent charging even when not in use. Batteries that must be charged for the purpose of later discharge will decrease their internal charges with time and even can become damaged from being discharged to low.

In contrast, in the present invention no reaction or power drain occurs unless the cell or cells are activated by the user. These power supplies can be powered from Iron—Air, Zinc—Air, Sodium—Air, Magnesium—Air, Titanium—Air, Aluminum—Air, Lithium—Air, Beryllium—Air chemistries to name a few. In this way an on demand power device will have power available even after years of waiting and non use. When a situation arises were power must be available, the power will be readily available and will not require any user maintenance or constantly require charging. These units can even be refurbished to replace the chemicals after they have been discharged and allow the device to be operated at any time necessary in the future.

The Chemical Battery(s) store the energy for the on demand power device and vary in size and quantity depending on the model, power generated and delivery system required. While this is a single use type power storage system the unit can have the spent chemicals removed and be supplied with new chemicals that would allow the system to be operated one time and on demand again.

The Reaction Power Regulator initiates and controls the chemical reaction and the power to provide the power device with the voltage and current rating of the on demand power device.

The Reaction Power Activators provides the user with a means to start the on demand power device and proved power to the device it is connected to or installed in. The amount of power generated can be determined by how many cells within the power device are activated. Multiple pull tabs, punctures and/or twist release mechanisms will be utilized to activate the reaction for each cell bank. In this manner the power device can be utilized multiple times with smaller currents for each use or all at one time to provide a large current on a single use.

Power Connection provides a means for the on demand power device to transfer energy to the equipment or device requiring power. This power connection can be a cord or leaded assembly with a plug, connector or metal piece that allows for contact to deliver power to devices the unit(s) are connected to or installed in.

The figures presented herein provide examples of various configurations that allow for ease of storage for the unit and allow for different storage locations. These on demand power supplies can even mimic or replicate the shape of existing battery or non-battery items as desired.

### BRIEF DESCRIPTION OF THE DRAWINGS

FIG. 1 shows the preferred embodiment of the On Demand Power Device, partially cut away to show the interior of the device.

FIG. 2 shows a view of the preferred embodiment of the On Demand Power Device.

FIG. 3 shows an alternate embodiment of the On Demand Power Device.

FIG. 4 shows an alternate embodiment of the On Demand Power Device.

FIG. 5 shows an alternate embodiment of the On Demand Power Device.

FIG. 6 shows an alternate embodiment of the On Demand Power Device.

FIG. 7 shows a side view of the On Demand Power Device in FIG. 6.

FIG. 8 presents a schematic of the preferred embodiment of the On Demand Power Device.

FIG. 9 presents a schematic of an alternate embodiment of the On Demand Power Device.

FIG. 10 presents a schematic of an alternate embodiment of the On Demand Power Device.

FIG. 11 presents a schematic of an alternate embodiment of the On Demand Power Device.

FIG. 12 presents a schematic of an alternate embodiment of the On Demand Power Device.

FIG. 13 presents a schematic of an alternate embodiment of the On Demand Power Device.

FIG. 14 presents a schematic of an alternate embodiment of the On Demand Power Device.

FIG. 15 presents a schematic of an alternate embodiment of the On Demand Power Device.

FIG. 16 presents a schematic of an alternate embodiment of the On Demand Power Device simultaneously employing multiple configurations of the circuit branches.

FIG. 17 presents a schematic of an exemplary configuration of circuit branches of the On Demand Power Device.

FIG. 18 presents a schematic of an exemplary configuration of circuit branches of the On Demand Power Device.

FIG. 19 presents a schematic of an exemplary configuration of circuit branches of the On Demand Power Device.

FIG. 20 presents a cell configuration diagram.

FIG. 21 presents a cell configuration diagram.

FIG. 22 presents a cell configuration diagram.

FIG. 23 presents a cell configuration diagram.

### DETAILED DESCRIPTION OF THE INVENTION

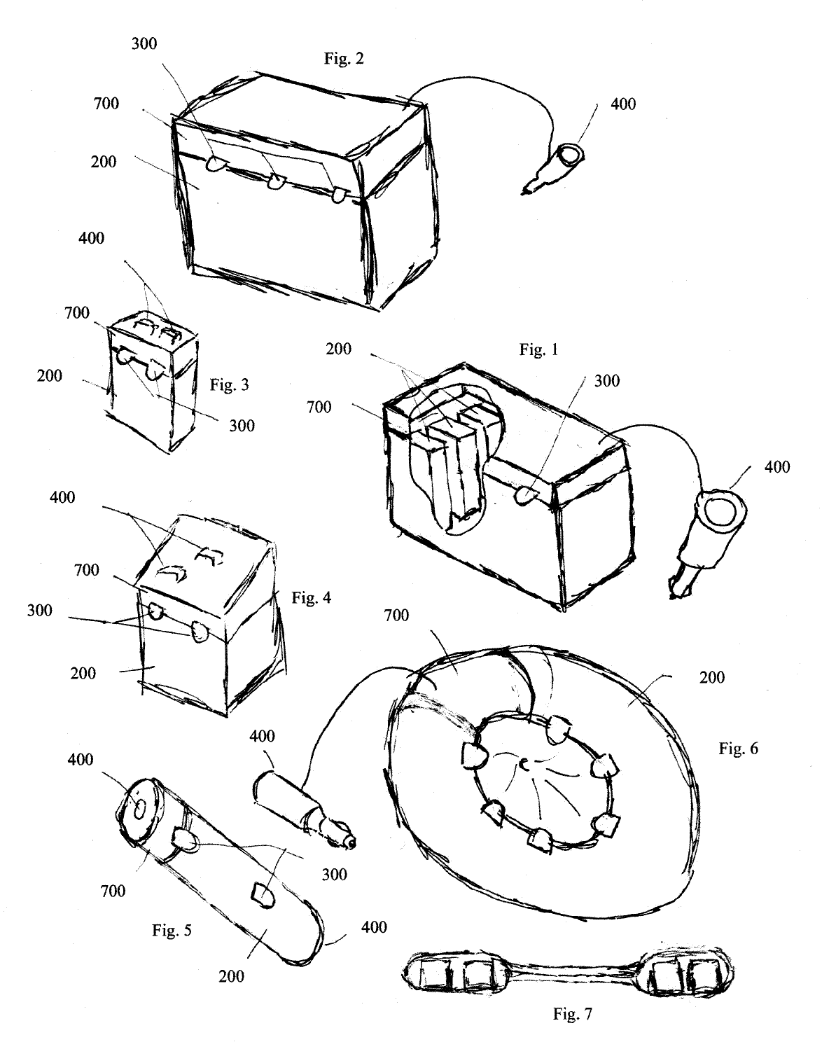

The On Demand Power Device 100, as shown in the preferred embodiment of FIG. 1, and also shown in the alternate embodiments of FIGS. 2-23, consists of at least one chemical battery cell 200, at least one reaction power activator 300, a power connection 400, and an enclosure 500, and associated circuitry 600.

In some of the various alternate embodiments disclosed herein the On Demand Power Device 100 further includes at least one reaction power regulator 700.

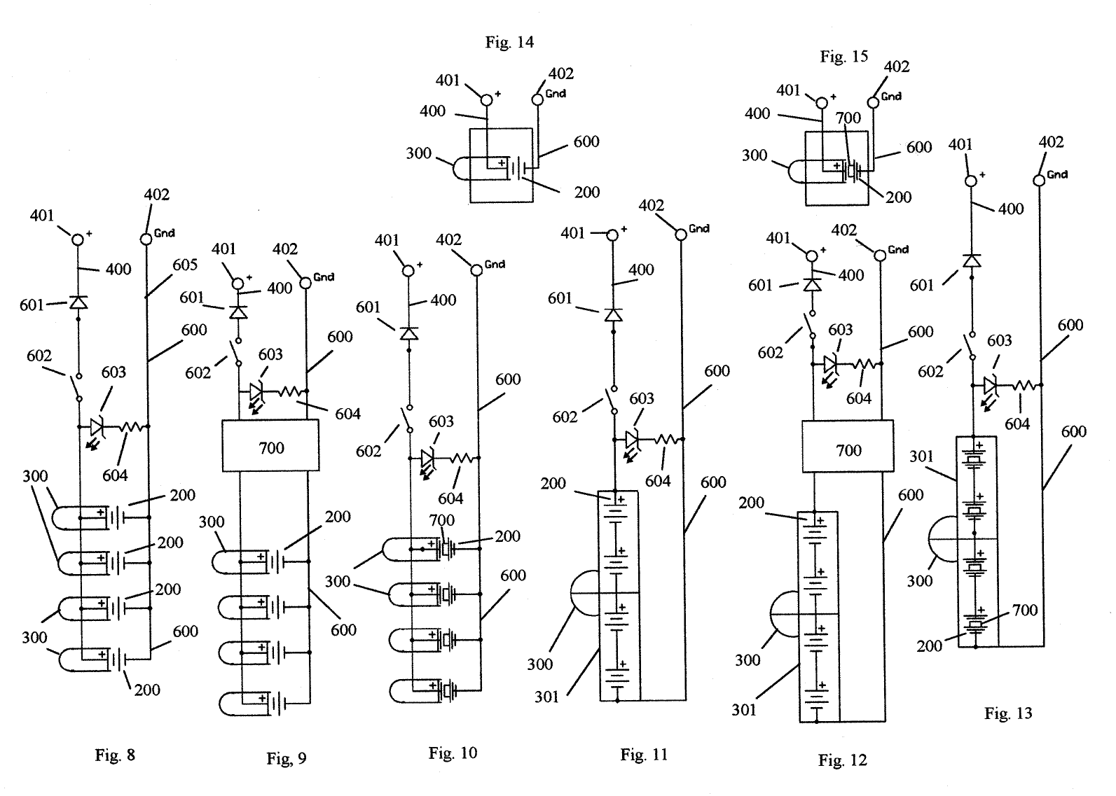

Turning now to the preferred embodiment as shown in FIG. 1 and FIG. 8, the On Demand Power Device 100 includes an enclosure 500 which houses at least one chemical battery cell 200, a power connection 400, and associated circuitry 600 connecting the battery cell (s) 200 to the power connection 400.

Each battery cell 200 includes a reaction power activator 300 which, when activated, initiates and controls the chemical reaction within the battery cell 200 to provide power, voltage, and current to the On Demand Power Device 100. The specific reaction power activator 300 used in each configuration is selected to allow the intermixing and/or flow of chemicals in the battery cell 200 thereby initiating the electrochemical reaction which produces electricity.

In the preferred embodiment the reaction power activator 300 is a pull-tab which allows the users to grasp and pull a strip of material (such as plastic, metal, or non-metallic material) thereby selectively initiating the chemical reaction only within a selected cell. These pull-tabs include indicia and/or color coding which indicates the voltage/power/current obtained from activating the selected cell or group of cells. Other commonly known information methods (such as using labels on the enclosure, a supplemental instructional guide, or flags having indicia or coloring) are understood to be within the scope of the instant invention with regards to methods for indicating the voltage/power/current obtained from activating the selected cell or group of cells.

Further, the specific reaction power activator 300 used in each configuration is selected so that until the reaction power activator 300 is activated (such as by removal of an element separating the cells chemicals) the reaction power activator 300 inhibits the electrochemical reaction within the cell thereby preventing the production of electricity.

Some of the cells 200, as indicated at least in FIGS. 8-10 and 14-15, have a reaction power activator 300 which can be activated without activating other cells 200.

As indicated at least in FIGS. 11-13, groups of cells 200 can also share a common reaction power activator 300 and are therefore activated together as a group.

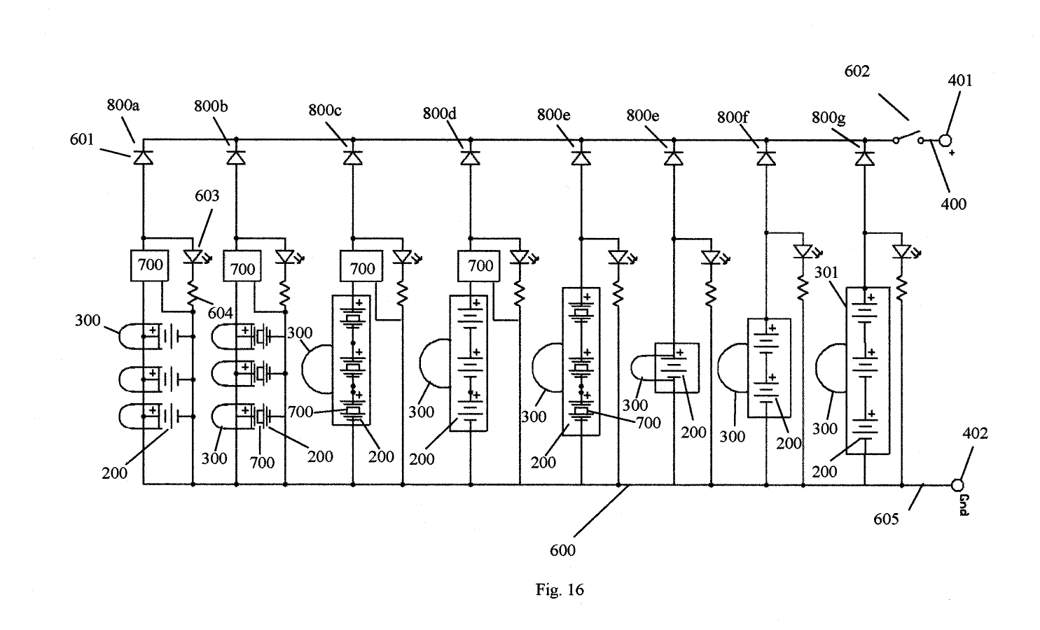

As shown in FIG. 16, the On Demand Power Device 100 can contain both independently activated cells and as well as cells which are activated in groups. This novel variety of configurations allows users of the On Demand Power Device 100 to selectively activate a single cell or groups cells to obtain the desired power output.

Alternate activation means for activating the selected cell(s) 200 which are understood as applicable to the instant invention are methods which selectively allow the intermixing and/or flow of chemicals in the battery cell(s) 200 wherein such means include plungers, puncturing mechanisms, mechanical arrangements, electronic arrangement, pyrotechnic arrangements, manual arrangements, as well as automatic arrangements.

Power connection 400 is provided via a standard cigarette lighter adapter or similar type outlet. Alternative configurations for the shape and form of the connector of the power connection 400 are understood to be within the scope of the instant inventions as applicable to the specific application. For example if the On Demand Power Device 100 were being used to power a cell phone, a radio, a computer, camping equipment, towing equipment, nautical equipment, aviation equipment, etc, a suitable connector would be selected and used. Where the On Demand Power Device 100 is used to jump-start an automobile engine or deliver large quantities of power/voltage/current, suitable connectors such as jumper cable or alligator type clamps can be connected to the power out 401 and ground 402 used as needed.

The associated circuitry 600 electrically controls the flow of current, voltage, and power within the On Demand Power Device 100. The associated circuitry 600 includes at least power out 401 and ground (Gnd) 402 locations on the power connection 400.

Preferably the associated circuitry 600 includes an output diode 601, an output switch 602, a regulating and/or illuminating diode 603, a regulating and/or output resister 604, and a ground path 605. The output switch 602 allows the cell to be connected or disconnected from the output diode 601. The regulating and/or illuminating diode 603 when illuminated provides an indication the cell is producing output voltage. The output switch 602 and the regulating and/or illuminating diode 603 may be provided on the exterior of the enclosure 500 or within the enclosure 500. The cathode (output end) of the output diode 601 and the ground path 605 of the associated circuitry are connected to power connection 400 respectively at power out 401 and ground (Gnd) 402 locations on the power connection 400.

The reaction power regulator 700 is presented as ports, orifices, holes, or porous membranes which are used to meter the flow of air and/or selected gases or fluid (including oxygen or other known gases) into and out of the cell(s) to facilitate the chemical reaction within the cell(s). The reaction power regulator 700 may also include supplemental metering elements such as various sized membranes, flaps or reeds (not shown) to allow the adjustment of the flow rate of the gases or fluid.

Further, the reaction power regulator 700 can contain typical voltage, current, and power regulation elements commonly used in power management systems. These components typically include Zener diodes, bridge networks, clamping networks, filtering networks, MOSFETS, UJTS, integrated circuits, passive voltage/power/current regulation components and active voltage/power/current regulation components.

As shown in FIGS. 9 and 12, the embodiments include a reaction power regulator 700 external to the individual cell(s) 200. In these configurations the reaction power regulator 700 is provided on the body of the enclosure 500 (not shown) or provided as a component of the enclosure 500, see FIGS. 1-8.

Alternatively, as indicated in FIGS. 10, 13, and 15 the reaction power regulator 700 may be presented as an integral component of each cell 200. This allows the selection of a variety of reaction power regulators 700 best suited for each specific cell 200. For example where a battery or On Demand Power Device 100 consists of cells of different chemical composition, the reaction power regulators 700 would allow, in a single battery, the use of differing rates of gases or fluid flow consistent with the chemicals of the specific cell 200. Cell manufacturers would calibrate each cells reaction power regulator 700 to provide the optimum power output.

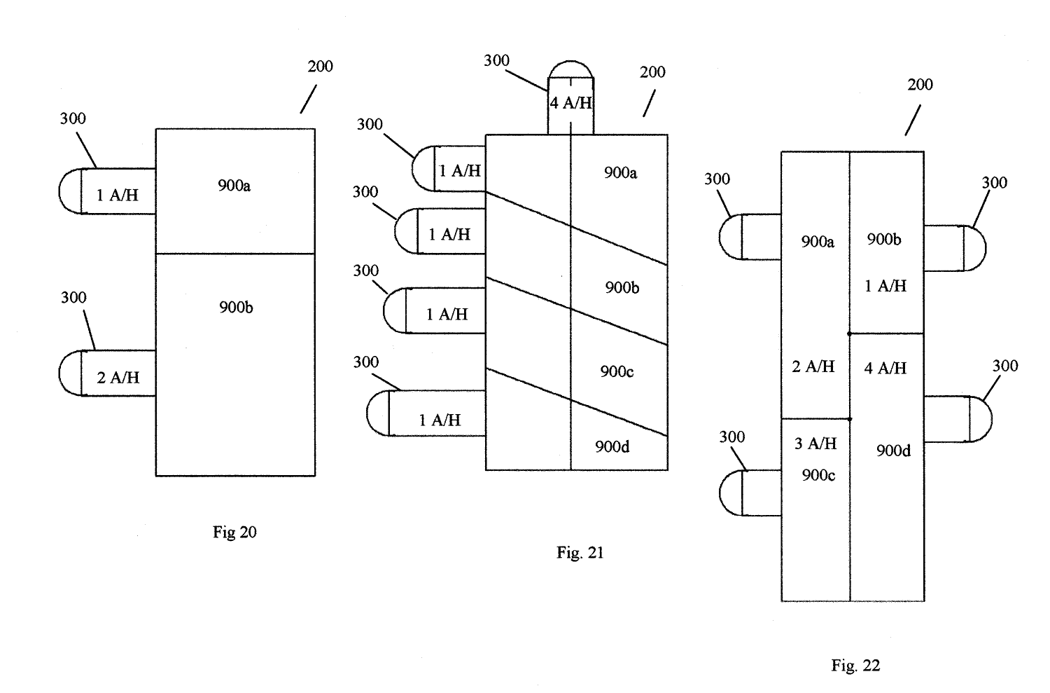

Further, as shown in FIG. 20 a cell 200 may be partitioned to include multiple sections 210 wherein each cell section 210 can contain a different chemical compound(s), different chemical compound(s) concentration, or different cell section volume as at least one other section 210 of the same cell 200. Alternatively the cell sections 210 of a cell may contain the same chemical compound(s), same chemical compound(s) concentration, or same cell section volume as at least one other section of the same cell 200. Further a cell 200 may contain cell sections 210 which are the same chemical compound(s), same chemical compound(s) concentration, or same cell section volume as at least one other section of the same cell 200 concurrently with cell containing at least one cell section 210 having a different chemical compound(s), different chemical compound(s) concentration, or different cell section volume as at least one other section 210 of the same cell 200.

As shown in FIG. 16, circuit branches 800a-800g are provided wherein each circuit branch extends from the cathode of the applicable output diode 601 to the ground path 605 and encompasses the electronic components in-between.

As shown circuit branches 800a-800g in FIG. 16, the On Demand Power Device 100 may contain a variety of configurations which allows the On Demand Power Device 100 to selectively regulate cells of varying chemical compositions and varying voltages.

Exemplary configurations are provided in the circuit branches of FIG. 16 such as wherein reaction power regulators 700 are presented as an integral component of each cell 200 and a reaction power regulator 700 is provided external to the individual cell(s) 200 (such as within a sub-compartment of the enclosure which houses a group of cells). For example, if the cells within the sub-compartment are composed of the different materials, the reaction power regulator 700 for the specific cells would be calibrated for that specific cell while the overall circuit branch may also have a separate reaction power regulator 700 calibrated to function with the output regulator 700 of each cell or cell group to optimize the out of the total circuit branch.

Exemplary configurations are also provided in the circuit branches which do not include a reaction power regulator 700 but rather present different numbers of cells in the circuit branch (see circuit branches 800e-800g). This allows the specific circuit branch to provide a power, voltage, or current would be different than circuit branches which have more cells or fewer cells of the same type.

Note, some of the circuit elements of FIG. 16-19 which are the same in each circuit branch were not repeatedly labeled in each circuit branch so that the schematic would be less cluttered. Omission of the label for the element is not an indication that the unnumbered element is different from the comparable element in another circuit branch. For example, each branch includes an output diode 601, an illuminating and/or regulating diode 603, and a regulating and/or output resister 604 which are shown but not labeled in each and every circuit branch.

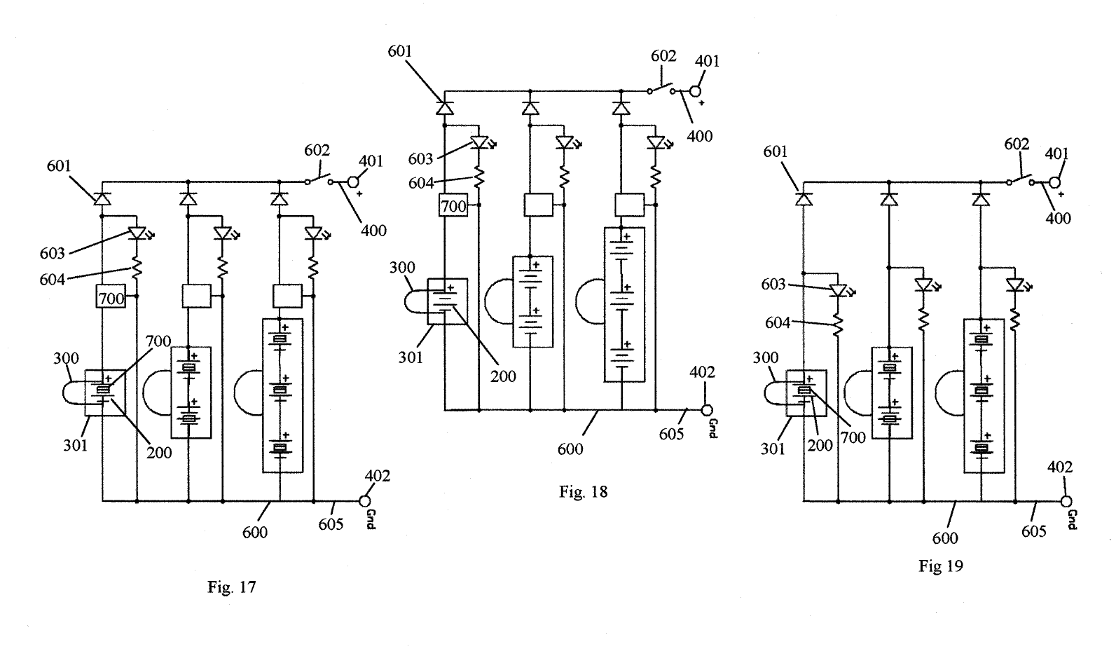

FIGS. 17-19 present exemplary circuit branch configurations which include 1, 2, and 3 cells 200 in parallel. This configuration discloses that parallel circuit branches can have a single cell 200 with a reaction power activator 300 in parallel with groups of cells 200 wherein the groups of cells 200 have their own reaction power activator 300.

Further, as shown in FIG. 17, each cell 200 or groups of cells 200 can internally have a reaction power regulator 700 while the cell(s) 200 form part of a circuit branch wherein the circuit branch also includes a reaction power regulator 700.

As shown in FIGS. 20-21 each cell 200 can be partitioned (see 900a-900d) and distinct voltage/current/power generating electrochemical solutions can be provided within each partition section thereby providing differing voltage/current/power and/or amp-hour (A/H) capacity within each cell partition section. Each cell partition section includes a reaction power activator 300 so that users can select and activate the desired voltage/current/power and/or amp-hour (A/H) capacity independent of the voltage/current/power and/or amp-hour (A/H) capacity provided by other cell partition sections of the same cell 200.

Each cell partition section would be calibrated by the manufacturer to provide the rated voltage/current/power and/or amp-hour (A/H) capacity, wherein such calibration may include selecting the appropriate reaction power regulator method and reaction power regulation components optimally suited for the specific cell partition section geometry, desired output, and electrochemical solutions.

A cell may contain cell partition sections which have differing cell partition section geometry, differing cell partition section chemistry, and use different reaction power regulator methods from other cell partition sections within the same cell but still deliver the same voltage/current/power and/or amp-hour (A/H) capacity as other cell partition sections in the same cell.

As shown in FIG. 21, users can, by activating a single reaction power activator 300 choose to active either 1 A/H at a time, individually by pulling each “1 A/H” tab as needed, or users can by activating a single reaction power activator 300 select the total available amp-hours (i.e. 4 A/H) for a single use at one time (by pulling the “4 A/H” tab).

Further a single cell can have one or more reaction power activator(s) 300 that allow for different chemical flow rates and/or reaction flow rates to occur and therefore produce varying electrical outputs consistent with the chemical reaction.

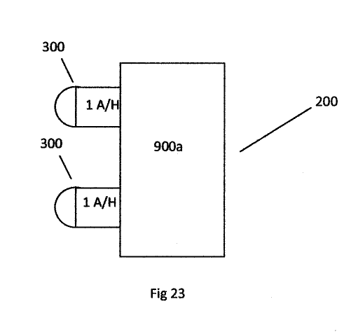

For example as shown in FIG. 23, a single cell may have a first and a second tabbed reaction power activator 300. If the first tabbed reaction power activator 300 is activated by removing the tab without activating the second tabbed reaction power activator 300, then the power produced by the cell will be of a lesser amount than if both reaction power activator tabs 300 are activated. In this example the removal of each tabbed activator 300 allows for an amount of air flow for the chemical reaction in the cell therefore removal of multiple tabbed activators 300 increases the air flow and therefore increases the chemical reaction and power and electrical output of the cell.

Operation and Usage

For typical usage the user simply pull the reaction power activator 300 tab(s) which indicate the desired power/voltage/current or amp-hour (A/H) capacity, activate the output switch 602, attach the On Demand Power Device 100 to the appropriate appliance adapter (such as standard cigarette lighter adapter or similar type outlet), and then attach the adapter to the item requiring power.

Once the power/voltage/current or amp-hour (A/H) capacity available from a selected cell or group of cells is depleted, the user can select other un-depleted cells or groups of cells available on the On Demand Power Device 100.

The user can deactivate the output switch 602 at any time to disconnect the cells from the power connection 400. Where applicable, with power disconnected from the output connection the regulating and/or illuminating diode 603 will continue to glow as the cell or cells 200 in the applicable circuit branch 800 discharges.

As presented herein the term ‘power’ generally also refers to voltage/current/power and/or amp-hour (A/H) capacity unless such use is repugnant to the usual meaning of the term “power”. For example, the selection of the most appropriate output needed by the user may rely on the amp-hour needs of the device the users is connecting to the On Demand Power Device 100 or it may rely on the voltage requirements of the device the users is connecting to the On Demand Power Device 100 and the appropriate voltage/current/power and/or amp-hour (A/H) capacity selection is made available by the instant device according to the user needs, not withstanding that the title of the instant invention.

While various embodiments of the present invention have been shown and described herein, it will be obvious that such embodiments are provided by way of example only. Numerous variations, changes, substitutions, and embodiment combinations may be made without departing from the invention herein. Accordingly, it is intended that the invention be limited only by the spirit and scope of the appended claims.

What is claimed is:

1. An on-demand power device providing user selectable output power comprising:
an enclosure;
at least one activatable chemical battery cell provided within the enclosure
wherein a chemical reaction within each cell generates an electrical charge when the cell is activated;
a reaction power activator connected to each cell, wherein the reaction power activator activates the selected cell;
power connections connected to each cell,
wherein after the applicable reaction power activator is activated the chemical reaction within the selected cell generates an electrical charge within the cell.

2. The device of claim 1 having a plurality of activatable chemical battery cells wherein at least one activatable chemical battery cell is independently activatable from among the plurality of activatable chemical battery cells.

3. The device of claim 2 wherein multiple cells of the plurality of activatable chemical battery cells are activated together as a group without requiring activation of all cells of the plurality of activatable chemical battery cells.

4. The device of claim 3 wherein while multiple cells of the plurality of activatable chemical battery cells are activated together as a group, at least one additional activatable chemical battery cell is activated separately from the group.

5. The device of claim 3 wherein some of the plurality of activated cells consists of cells of differing electrical charge capacity or differing electro-chemical materials from other activated cells.

6. The device of claim 5 wherein at least one of the activatable chemical battery cells includes at least two cell partition sections wherein differing electro-chemical materials are provided in each cell partition section.

7. The device of claim 6 wherein cell partition sections are of differing electro-chemical material containing volumes.

8. An on-demand power device providing user selectable output power comprising:
an enclosure;
at least one activatable chemical battery cell provided within the enclosure wherein a chemical reaction within each cell generates an electrical charge when the cell is activated;
wherein each cell includes a reaction power regulator to regulate the electrical output of the cell;
a reaction power activator connected to each cell, wherein the reaction power activator activates the selected cell;
power connections connected to each cell,
wherein after the applicable reaction power activator is activated the chemical reaction within the selected cell generates an electrical charge within the cell.

9. The device of claim 8 having a plurality of activatable chemical battery cells wherein at least one activatable chemical battery cell is independently activatable from among the plurality of activatable chemical battery cells.

10. The device of claim 9 wherein multiple cells of the plurality of activatable chemical battery cells are activated and regulated together as a group without requiring activation and regulation of all cells of the plurality of activatable chemical battery cells.

11. The device of claim 10 wherein while multiple cells of the plurality of activatable chemical battery cells are activated and regulated together as a group, at least one additional activatable chemical battery cell is activated and regulated separately from the group.

12. The device of claim 10 wherein some of the plurality of activated cells consists of cells of differing electrical charge capacity or differing electro-chemical materials from other activated cells.

13. The device of claim 12 wherein at least one of the activatable chemical battery cells includes at least two cell partition sections wherein differing electro-chemical materials are provided in each cell partition section.

14. The device of claim 13 wherein cell partition sections are of differing electro-chemical material containing volumes.

15. A method for providing on demand user selectable output power including:
providing an enclosure;
providing at least one activatable chemical battery cell provided within the enclosure wherein a chemical reaction within each cell generates an electrical charge when the cell is activated;
wherein each cell includes a reaction power regulator to regulate the electrical output of the cell;
providing a reaction power activator connected to each cell, wherein the reaction power activator activates the selected cell;
providing power connections connected to each cell;
activating at least one activatable chemical battery cell thereby generating an electrical charge within the activated cell.

16. The method of claim 15 further including:
providing a plurality of activatable chemical battery cells;
activating multiple cells of the plurality of activatable chemical battery cells together as a group without requiring activation of all cells of the plurality of activatable chemical battery cells.

17. The method of claim 16 further including:
providing at least two cell partition sections in some of the cells of the activated cell group;
providing differing electro-chemical materials in at least two of the cell partition sections;
providing differing electro-chemical material containing volumes in at least two of the cell partition sections;
generating the same electrical output from each cell partition section.

18. The device of claim 1 having a plurality of reaction power activators in a single activatable chemical battery cell, wherein at least one reaction power activator is independently activatable from among the plurality of reaction power activators.

19. The device of claim 8 having a plurality of reaction power activators in a single activatable chemical battery cell, wherein at least one reaction power activator is independently activatable from among the plurality of reaction power activators.

20. The device of claim 15 having a plurality of reaction power activators in a single activatable chemical battery cell, wherein at least one reaction power activator is independently activatable from among the plurality of reaction power activators
